(19) United States
(12) Patent Application Publication
(10) Pub. No.: US 2024/0238817 A1
(43) Pub. Date: Jul. 18, 2024

(54) Nozzle Plate for Spray Gun Applicator and Spray Gun Applicator Including Same

(71) Applicant: Marshalltown Company, Marshalltown, IA (US)

(72) Inventors: Tim Florio, Fayetteville, AR (US); Lance Hayes, Bentonville, AR (US)

(21) Appl. No.: 18/411,016

(22) Filed: Jan. 11, 2024

Related U.S. Application Data
(60) Provisional application No. 63/479,630, filed on Jan. 12, 2023.

(51) Int. Cl. B05B 9/01; B05B 15/62

(52) U.S. Cl. CPC B05B 9/01; B05B 15/62

(57) ABSTRACT

A nozzle plate for a spray gun applicator includes a plate body that rotatably couples to a distal end of the spray gun body. Discrete nozzles on the plate body are selectively and individually positioned in communication with the fluid passage of the spray gun body by rotating the nozzle plate relative to the distal end of the spray gun body about a rotational axis. One or more of the discrete nozzles is a wide nozzle defining an orifice having a proximal inlet and a distal outlet. The orifice flares from the proximal inlet to the distal outlet. The distal outlet has an oblong shape.

### CROSS-REFERENCE TO RELATED APPLICATIONS

The present application claims the benefit of U.S. Provisional Application No. 63/479,630, filed Jan. 12, 2023, the entirety of which is hereby incorporated by reference.

### FIELD OF THE DISCLOSURE

The present disclosure generally relates to a nozzle plate including a plurality of nozzles and a spray gun applicator including the same.

### BACKGROUND OF THE DISCLOSURE

A number of devices are available for applying texture material to surfaces such as walls or ceilings of buildings. These texture material applicators have evolved from labor-intensive manual tools to modern powered devices. Modern texture material applicators are often in the form of spray guns. Compressed gas (often air) is used to expel texture material from the spray gun in response to a user operated trigger. A spray gun applicator mounted hopper or a supply line supply texture material to the gun during use.

An example of an applicator is shown in U.S. Pat. No. 5,232,161 issued to Clemmons. The Clemmons patent discloses a spray gun applicator having a user-activated spring biased trigger. The texture material enters the spray gun from a source located above the gun.

The texture material is then expelled from the gun by means of compressed air which is supplied at the rear of the gun. The texture material is expelled from a mixing orifice at the front of the gun and passes through a pattern defining orifice plate. The pattern defining orifice plate contains a plurality of orifices of differing sizes which may be positioned over the mixing orifice to control the size of the plume of expelled texture material.

### SUMMARY OF THE DISCLOSURE

In one aspect, a spray gun applicator generally comprises a spray gun body configured to dispense a flowable material at a distal end of the spray gun body. The spray gun body including a housing and a fluid passage in the housing through which the flowable material is dispensed. A nozzle plate is rotatably coupled to the distal end of the spray gun body. The nozzle plate includes a plate body and a plurality of discrete nozzles on the plate body configured to be selectively and individually positioned in communication with the fluid passage of the spray gun body by rotating the nozzle plate relative to the distal end of the spray gun body about a rotational axis. At least one of the plurality of discrete nozzles is a wide nozzle defining an orifice having a proximal inlet and a distal outlet. The orifice flares from the proximal inlet to the distal outlet. The distal outlet has an oblong shape.

In another aspect, a nozzle plate for a spray gun applicator generally comprises a plate body configured to be rotatable coupled to a distal end of the spray gun body. A plurality of discrete nozzles on the plate body are configured to be selectively and individually positioned in communication with the fluid passage of the spray gun body by rotating the nozzle plate relative to the distal end of the spray gun body about a rotational axis. At least one of the plurality of discrete nozzles is a wide nozzle defining an orifice having a proximal inlet and a distal outlet.

The orifice flares from the proximal inlet to the distal outlet. The distal outlet has an oblong shape.

### BRIEF DESCRIPTION OF THE DRAWINGS

FIG. 1 is an exploded perspective of one embodiment of a spray gun applicator including a nozzle plate.

FIG. 2 is a front elevation of the nozzle plate.

FIG. 3 is a side elevation of the nozzle plate.

FIG. 4 is a cross section of an upper wide nozzle taken through the plane 4-4 in FIG. 2.

FIG. 5 is a cross section of the upper wide nozzle taken through the plane 5-5 in FIG. 2.

FIG. 6 is a cross section of a lower wide nozzle taken through the plane 6-6 in FIG. 2.

FIG. 7 is a cross section of the lower wide nozzle taken through the plane 7-7 in FIG. 2.

FIG. 8 is an exploded perspective of another embodiment of spray gun applicator including a nozzle plate.

FIG. 9 is a side elevation of the spray gun applicator.

FIG. 10 is an enlarged, partial cross section of a distal end of the spray gun applicator, taken in a plane along a rotational axis of the nozzle plate.

FIG. 11 is a front elevation of the nozzle plate.

FIG. 12 is cross section of the nozzle plate taken through the plane 12-12 in FIG. 11;

FIG. 13 is cross section of the nozzle plate taken through the plane 13-13 in FIG. 11;

FIG. 14 is cross section of the nozzle plate taken through the plane 14-14 in FIG. 11; and

FIG. 15 is cross section of the nozzle plate taken through the plane 15-15 in FIG. 11.

### DETAILED DESCRIPTION OF THE DISCLOSURE

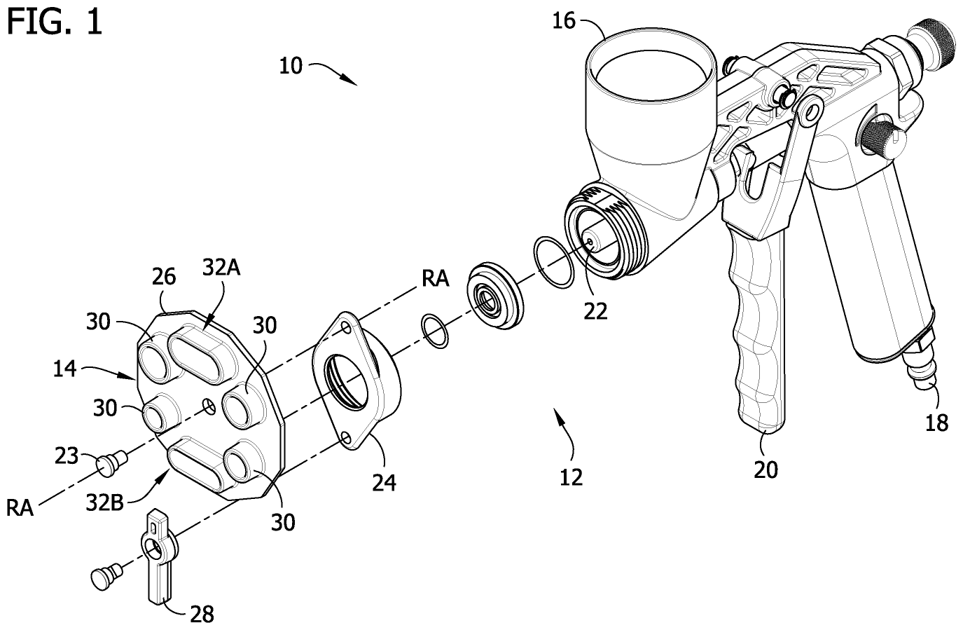

Referring to FIG. 1, a spray gun applicator is generally indicated at reference numeral 10. The spray gun applicator generally includes a spray gun body, generally indicated at 12, configured to dispense a flowable material; and a nozzle plate, generally indicated at 14, rotatably coupled to the spray gun body. In general, a hopper or other container or source of material (not shown) is coupled to the spray gun body 12 to supply flowable material (e.g., textured material) to the spray gun applicator. The spray gun body 12 includes hopper coupling 16 for coupling to the hopper or other source of flowable material, and a hose coupling 18 for coupling to a source of pressurize gas (e.g., air). A trigger 20 is selectively depressible to deliver pressurized flowable material through a barrel having a fluid passage, and an outlet 22 of the spray gun body 12 at a distal end of the body. The outlet 22 is the outlet of the fluid passage extending through the barrel, as shown in FIG. 1. The fluid passage may be defined or included in another component other than a barrel.

The nozzle plate 14 is rotatably coupled to the distal end of the spray gun body, such as by a fastener 23 (e.g., shoulder bolt) fastened to a nozzle plate coupler 24, to selectively enable rotation of the nozzle plate about a rotational axis RA. The nozzle plate 14 includes a plate body 26 and a plurality of a discrete nozzles on the plate body (described in more detail below) and spaced apart from one another around the rotational axis. As explained in more detail below, the nozzles are designed and constructed to produce different spray patterns for the pressurized texture material. Selective rotation of the nozzle plate 14 enables the user to select a desired one of the nozzles to be in fluid communication with the outlet 22 of the spray gun body 12 to produce the corresponding spray pattern. A locking lever 28 enables the user to selectively lock the nozzle plate 14 at a desired angular position to inhibit rotation of the plate, and unlock the nozzle plate to enable rotation of the plate and selection of another nozzle.

In the illustrated embodiment, the nozzle plate 14 includes at least two different nozzle types enabling the application of two different spray pattern types, apart from spray pattern size. That is, as used herein, spray pattern type is the shape of the spray pattern rather than the size of the spray pattern. The illustrated nozzle plate 14 includes at least one narrow (i.e., conventional) nozzle type 30 and at least wide nozzle type, generally indicated at 32A, 32B, respectively. In particular, the illustrated nozzle plate 14 includes four narrow nozzles 30 and two wide nozzles 32A, 32B. Each wide nozzle 32A, 32B is disposed between adjacent conventional nozzles 30 about the rotational axis RA. The narrow nozzles 30 have circular cross-sectional shapes and are described in U.S. Pat. No. 6,105,882, filed Nov. 25, 1998, the relevant teachings of which are incorporated by reference herein. These nozzles 30 are of different sizes to produce different sized spray patterns. These nozzles 30 may be of other types.

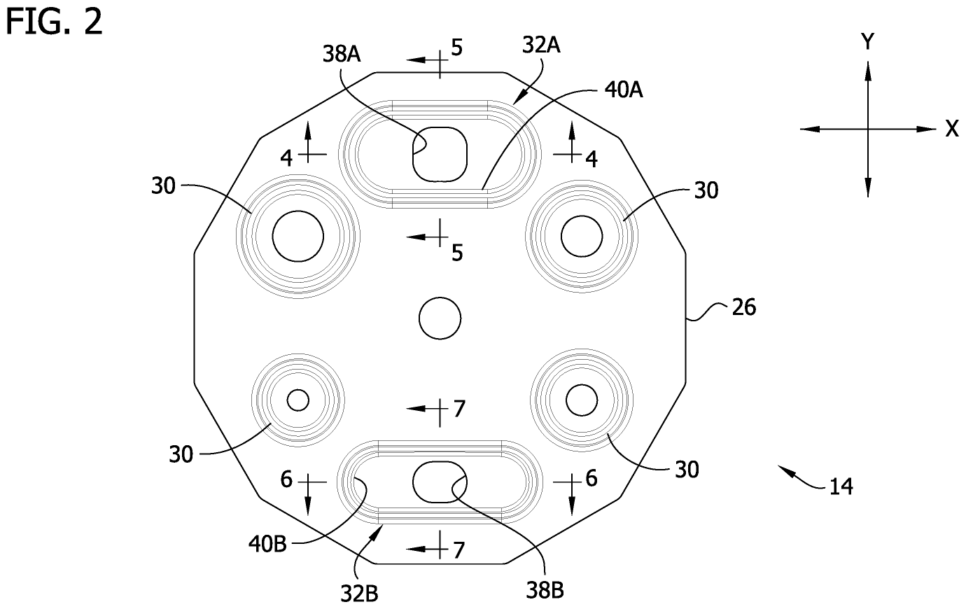

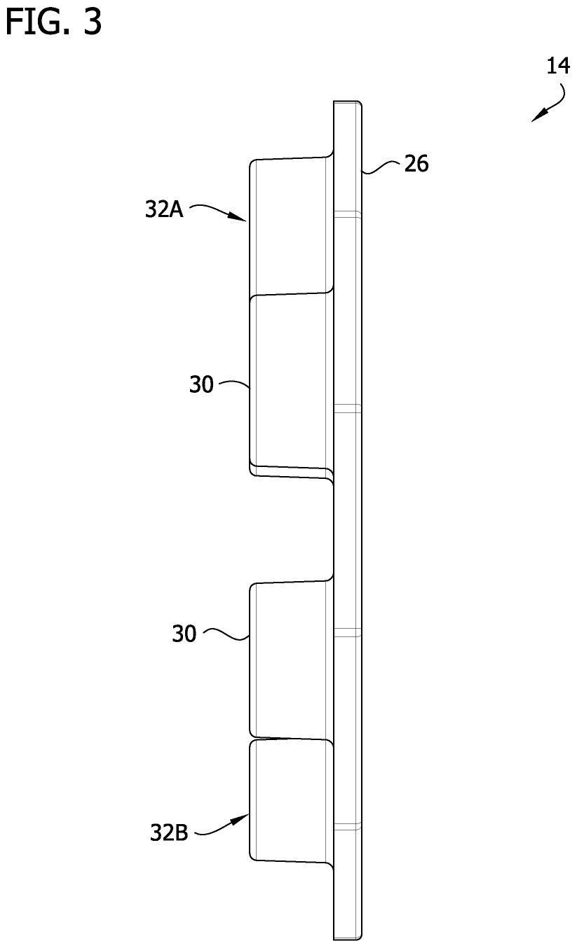

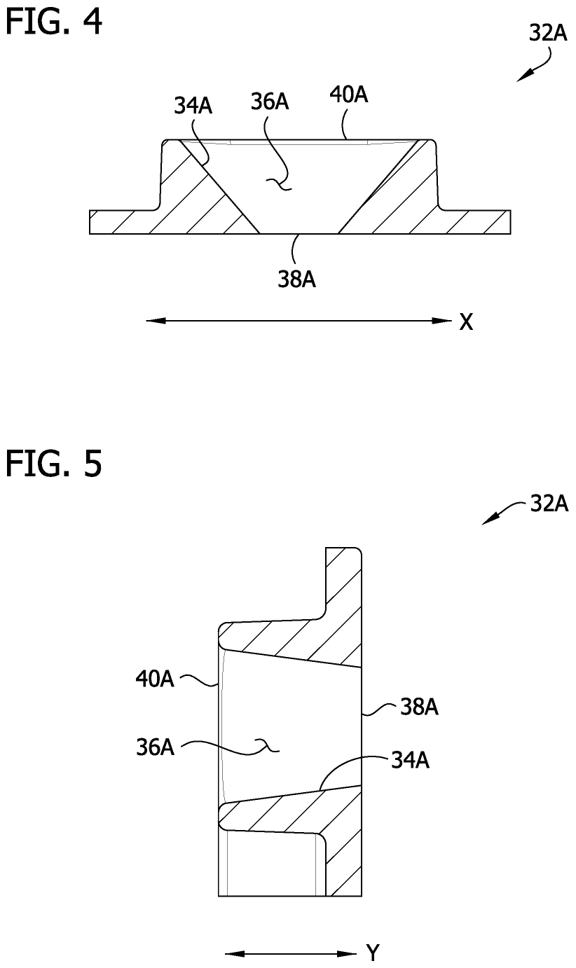

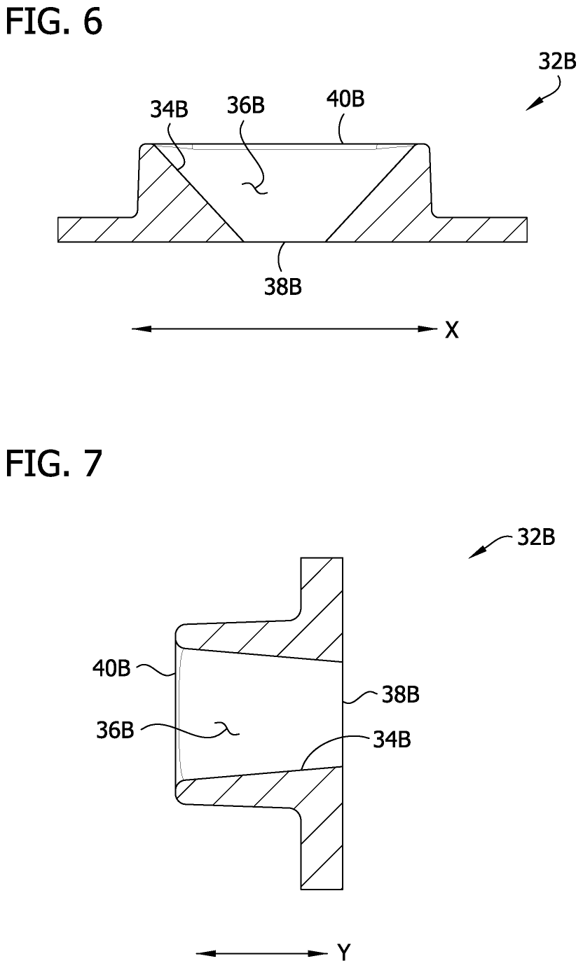

Referring to FIGS. 4-7, each wide nozzle 32A, 32B has an interior surface 34A, 34B, respectively, defining an orifice 36A, 36B, respectively, through which the pressurized material is delivered. Each orifice 36A, 36B has a proximal inlet 38A, 38B and a distal outlet 40A, 40B at respective proximal and distal ends of the nozzle 32A, 32B. As shown in FIG. 2, the inlet 38A, 38B may be generally circular, or oblong (e.g., oval or stadium shape), for example. The outlet 40A, 40B has an oblong shape, such as an oval or stadium shape. As also shown in FIG. 2, the illustrated outlet 40A, 40B has a stadium shape having opposite upper and lower straight sides and opposite right and left arcuate ends. The orifice 36A, 36B flares from the inlet 38A, 38B to the outlet 40A, 40B. The area of the outlet 40A, 40B may be 2 to 3 times greater than the area of the inlet 38A, 38B. The dimension of the outlet 40A, 40B along its minor axis (y-axis as shown in FIG. 5) may be 1.1 to 1.5 times greater than the dimension of the inlet 38A, 38B along the same axis (i.e., y-axis). The dimension of the outlet 40A, 40B along its major axis (i.e., x-axis) may be 2 to 4 times greater than the dimension of the inlet 38A, 38B along the same axis (i.e., x-axis). The illustrated interior surface 34A, 34B of the nozzle 32A, 32B has upper and lower portions extending from the inlet 38A, 38B to the upper and lower straight sides of the outlet (as shown in FIGS. 5 and 7), and right and left portions extending from the inlet to the left and right arcuate ends of the outlet (as shown in FIGS. 4 and 6). The upper and lower portions may be planar in cross section (FIGS. 5 and 7) and have flaring widths from the inlet 38A, 38B to the outlet 40A, 40B. The left and right portions may also be planar in cross section (FIGS. 4 and 6) and have flaring widths from the inlet 38A, 38B to the outlet 40A, 40B.

In the illustrated embodiment, the wide nozzles 32A, 32B have different sizes to produce different sized spray patterns of the same type. In particular, the areas of the inlet 38A and outlet 40A of the nozzle 32A are greater than the corresponding areas of the inlet 38B and outlet 40B of the nozzle 32B. The illustrated nozzles 32A, 32B have outlets 40A, 40B with equal dimensions along the major axis (i.e., x-axis). Moreover, the dimension of the minor axis (i.e., y-axis) of the wide nozzle 32A is greater than the dimension of the minor axis (i.e., y-axis) of the wide nozzle 32B.

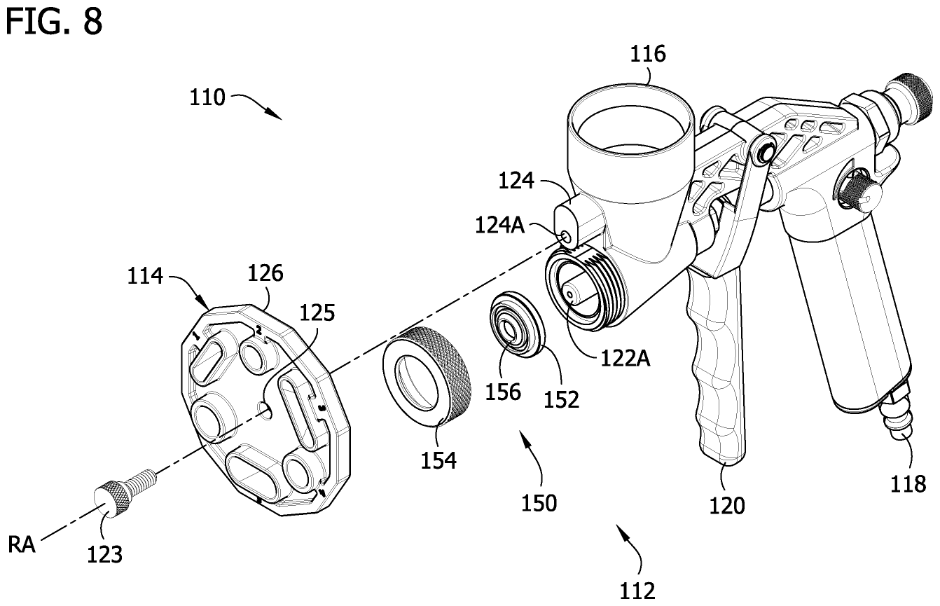

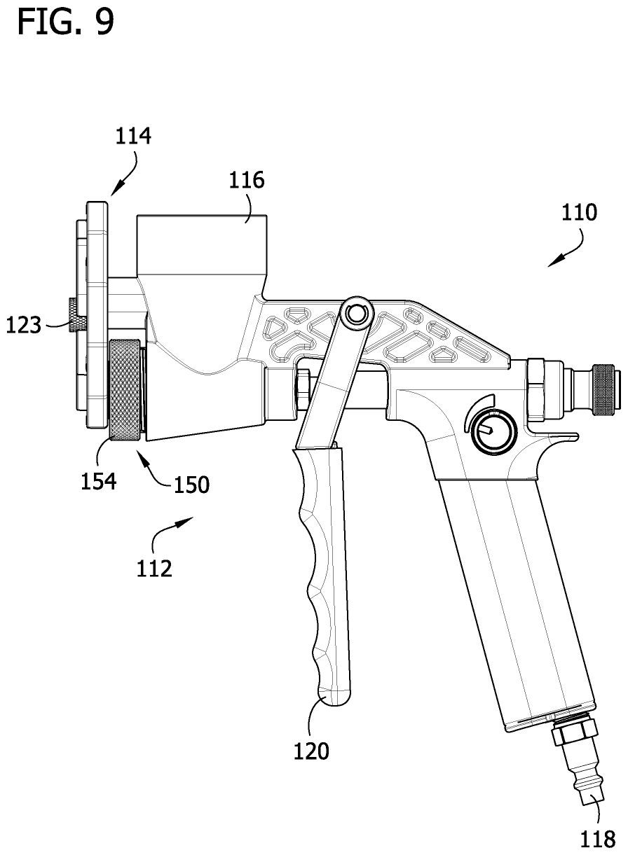

Referring to FIGS. 8 and 9, another embodiment of a spray gun applicator is generally indicated at reference numeral 110. The spray gun applicator 110 generally includes a spray gun body, generally indicated at 112, and a nozzle plate, generally indicated at 114, rotatably coupled to the spray gun body. In general, a hopper or other container or source of material (not shown) is coupled to the spray gun body 112 to supply textured material to the spray gun applicator. The spray gun body 112 includes hopper coupling 116 for coupling to the hopper or other source of texture material, and a hose coupling 118 for coupling to a source of pressurize gas (e.g., air). A trigger 120 is selectively depressible to deliver pressurized texture material through an opening at a distal end 122A of a barrel 122 received in the spray gun body 112. The barrel 122 has a fluid passage extending longitudinally therein. The fluid passage may be defined or included in another component other than a barrel. A cap, generally indicated at 150, is secured to (e.g., threaded on) the distal end of the spray gun body 112. The illustrated cap 150 includes a ferrule ring 152 and a collar 154 securing the ferrule ring to the spray gun body 112. The ferrule ring 152 (broadly, the cap 15) includes a tip portion 156 defining an opening in communication with the distal end 122 of the distal end 122A of the barrel 122. A proximal end of the tip portion 156 (e.g., proximal, tapering portion of the opening) is configured to receive and support the distal end 122 of the barrel 122.

The nozzle plate 114 is rotatably coupled to the distal end of the spray gun body, such as by a fastener 123 (e.g., shoulder bolt) fastened to a nozzle plate coupler 124, to selectively enable rotation of the nozzle plate about a rotational axis RA. In the illustrated embodiment, the nozzle plate coupler 124 is connected to or integrally formed with (i.e., coupled to) the spray gun body 112 at the distal end thereof. In the illustrated embodiment, the nozzle plate coupler 124 defines a threaded opening 124A for threadably mating with the fastener 123. The nozzle plate 114 includes a plate body 126 and a plurality of a discrete nozzles on the plate body (described in more detail below) and spaced apart from one another around the rotational axis RA. As explained in more detail below, the nozzles are designed and constructed to produce different spray patterns for the pressurized texture material. Selective rotation of the nozzle plate 114 enables the user to select a desired one of the nozzles to be in fluid communication with the outlet 122 of the spray gun body 112 to produce the corresponding spray pattern. In the illustrated embodiment, the fastener 123 extends through an opening 125 defined by the plate 114 at a central axis of the plate. The opening 125 may be at other locations in different embodiments.

In the illustrated embodiment, the nozzle plate 114 includes at least two different nozzle types enabling the application of two different spray pattern types, apart from spray pattern size. That is, as used herein, spray pattern type is the shape of the spray pattern rather than the size of the spray pattern. The illustrated nozzle plate 114 includes at least one narrow (i.e., circular or conventional) nozzle type 130, and at least wide nozzle type, generally indicated at 132A, 132B, 132C, respectively. In particular, the illustrated nozzle plate 114 includes three conventional, circular nozzles 130 and three wide nozzles 132A, 132B, 132C. Each wide nozzle 132A, 132B, 132C is disposed between adjacent conventional nozzles 130 about the rotational axis RA. The conventional nozzles 130 have circular cross-sectional shapes and are described in U.S. Pat. No. 6,105,882, filed November 25, 1998, the relevant teachings of which are incorporated by reference herein. These nozzles 130 are of different sizes to produce different sized spray patterns. These nozzles 130 may be of other types.

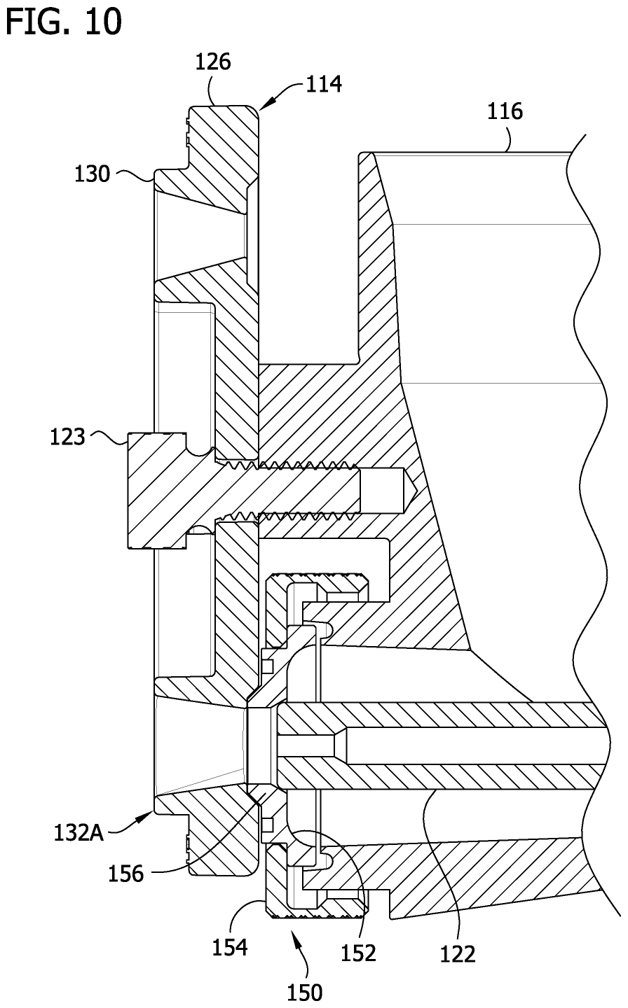

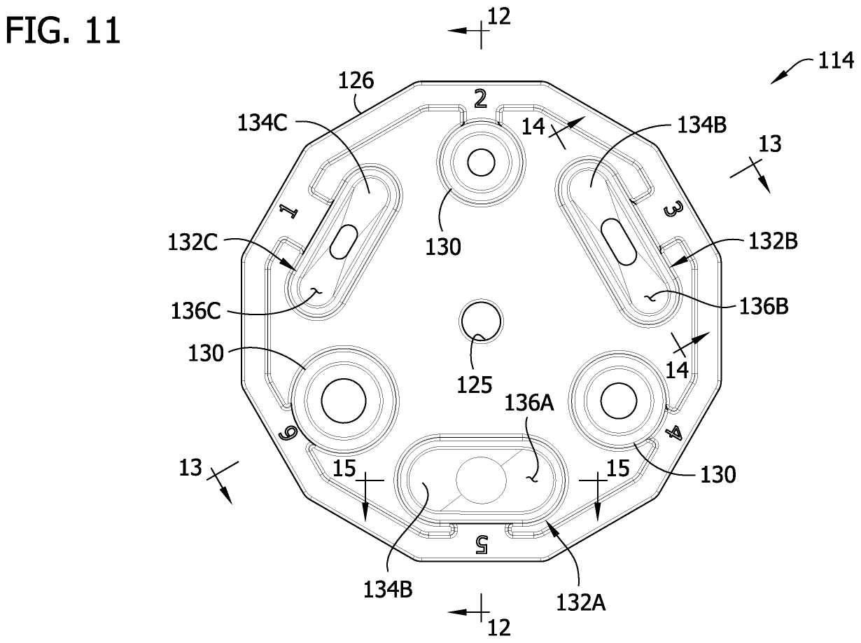

Referring to FIGS. 11-15, each wide nozzle 132A, 132B, 132C has an interior surface 134A, 134B, 134C, respectively, defining an orifice 136A, 136B, 136C, respectively, through which the pressurized material is delivered. Each orifice 136A, 136B, 136C has a proximal inlet 138A, 138B, 138C, and a distal outlet 140A, 140B, 140C at respective proximal and distal ends of the nozzle 32A, 32B. As shown in FIG. 2, the inlet 138A, 138B may be generally circular or oblong (e.g., oval or stadium shape), for example. In the illustrated embodiment, the plate 114 includes recesses or pockets 145 at the proximal side of the plate body 126. In one example, the plate body 126 defines the pockets 145. Each of the pockets 145 is in communication with one of proximal inlets 138A, 138B, 138C of the orifices 136A, 136B, 136C, and with one of the conventional nozzles 130 in a similar fashion. The pockets 145 may be substantially identical and sized and shaped to receive (e.g. nest with) the tip portion 156 of the cap 150 (e.g., the tip portion of the ferrule 152), as shown in FIG. 10. In particular, each of the illustrated pockets 145 has a tapering proximal end in which the distal end of the tip portion 156 nests, such that interior surface of the pocket circumferentially engages an exterior surface of the distal end of the tip portion and the tip portion “bottoms out” in the pocket to inhibit fluid from flowing between the tip portion and the plate.

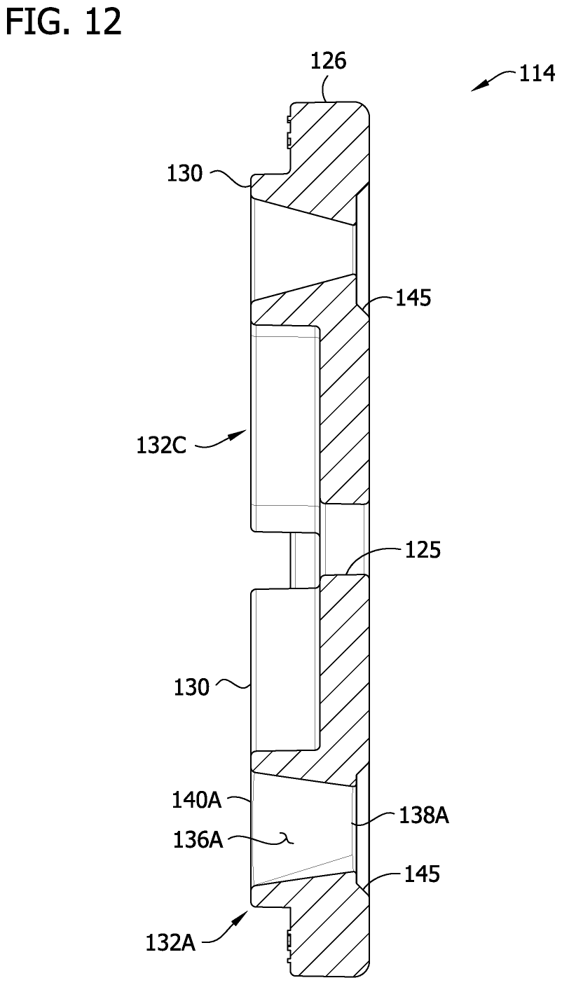

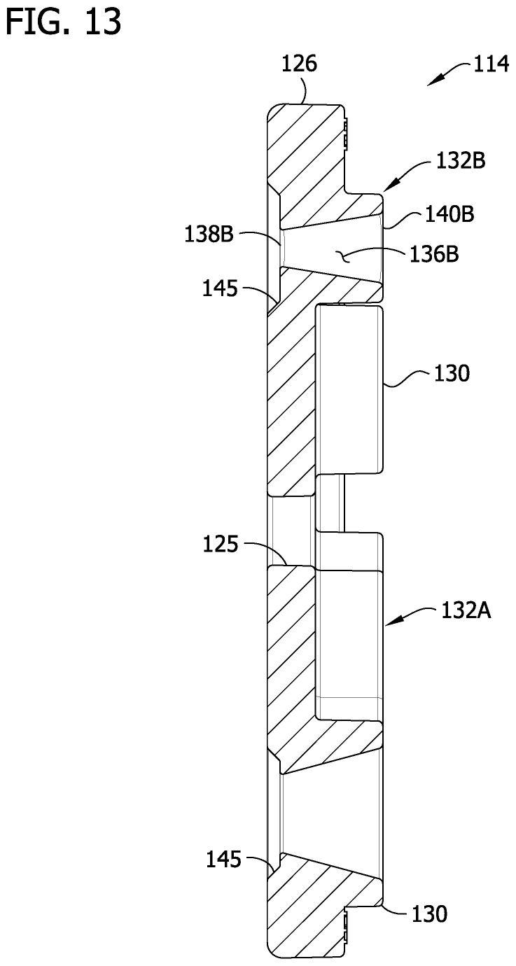

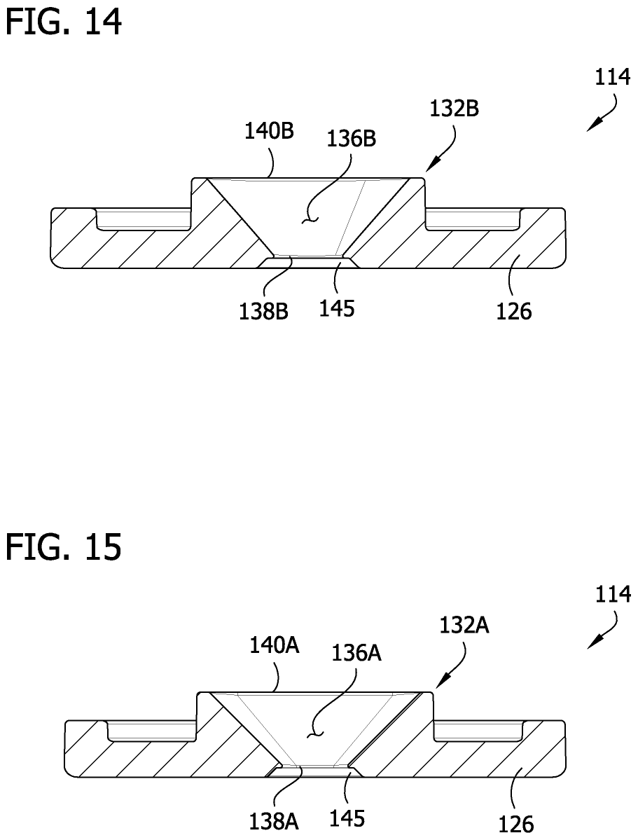

As also shown in FIG. 11, each outlet 140A, 140B, 140C may have racetrack shape having opposite upper and lower straight sides and opposite right and left arcuate ends. The orifice 136A, 136B, 136C flares from the inlet 138A, 138B, 138C to the outlet 140A, 140B, 140C. The area of the outlet 140A, 140B, 140C may be 2 to 3 times greater than the area of the inlet 138A, 138B, 138C. The dimension of the outlet 140A, 140B, 140C along its minor axis (y-axis as shown in FIGS. 12 and 13) may be 1.1 to 1.5 times greater than the dimension of the inlet 138A, 138B, 138C along the same axis (i.e., y-axis). The dimension of the outlet 140A, 140B, 140C along its major axis (i.e., x-axis as shown in FIGS. 14 and 15) may be 2 to 4 times greater than the dimension of the inlet 138A, 138B, 138C along the same axis (i.e., x-axis). The illustrated interior surface 134A, 134B, 134C of each nozzle 132A, 132B, 132C has upper and lower portions extending from the inlet 138A, 138B, 138C to the upper and lower straight sides of the outlet, and right and left portions extending from the inlet to the left and right arcuate ends of the outlet. The upper and lower portions may be planar in cross section and have flaring widths from the inlet 138A, 138B, 138C to the outlet 140A, 140B, 140C. The left and right portions may also be planar in cross section and have flaring widths from the inlet 138A, 138B, 138C to the outlet 140A, 140B, 140C.

In the illustrated embodiment, the wide nozzles 132A, 132B, 13C have different sizes to produce different sized spray patterns of the same type. In particular, the areas of the inlet 138A and outlet 140A of the nozzle 132A are greater than the corresponding areas of the inlet 138B and outlet 140B of the nozzle 132B, and the areas of the inlet 138B and outlet 140B of the nozzle 132B are greater than the corresponding areas of the inlet 138C and outlet 140C of the nozzle 132C.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A spray gun applicator comprising:
a spray gun body configured to dispense a flowable material at a distal end of the spray gun body, the spray gun body including a housing and a fluid passage in the housing through which the flowable material is dispensed; and
a nozzle plate rotatably coupled to the distal end of the spray gun body, the nozzle plate including a plate body and a plurality of discrete nozzles on the plate body configured to be selectively and individually positioned in communication with the fluid passage of the spray gun body by rotating the nozzle plate relative to the distal end of the spray gun body about a rotational axis,
wherein at least one of the plurality of discrete nozzles is a wide nozzle defining an orifice having a proximal inlet and a distal outlet,
wherein the orifice flares from the proximal inlet to the distal outlet, and
wherein the distal outlet has an oblong shape.

2. The spray gun applicator set forth in claim 1, wherein the distal outlet has an oval shape.

3. The spray gun applicator set forth in claim 2, wherein the distal outlet has a stadium shape.

4. The spray gun applicator set forth in claim 2, wherein at least one of the plurality of discrete nozzles is a conventional nozzle defining an orifice having a distal outlet with a circular shape.

5. The spray gun applicator set forth in claim 4, wherein the plurality of discrete nozzles comprises a plurality of the wide nozzles and a plurality of the conventional nozzles.

6. The spray gun applicator set forth in claim 5, wherein each wide nozzle is disposed between two conventional nozzles about the rotational axis.

7. The spray gun applicator set forth in claim 1, wherein the wide nozzle comprises at least two wide nozzles, wherein the distal outlets of the at least two wide nozzles have different sizes.

8. The spray gun applicator set forth in claim 7, wherein the distal outlets of the at least two wide nozzles have the same shapes.

9. The spray gun applicator set forth in claim 8, wherein at least one of the plurality of discrete nozzles is a conventional nozzle defining an orifice having a distal outlet with a circular shape.

10. The spray gun applicator set forth in claim 1, wherein the proximal inlet of the orifice is oblong.

11. The spray gun applicator set forth in claim 1, wherein the proximal inlet of the orifice is circular.

12. The spray gun applicator set forth in claim 1, wherein the nozzle plate further includes pockets at a proximal side of the nozzle plate body, each of the pockets in fluid communication with the proximal inlet of a corresponding one of the discrete nozzles,
wherein the spray gun body further includes a barrel defining the fluid passage, and a tip portion in which a distal end of the barrel is received to support the distal end of the barrel,
wherein each pocket is configured to receive the tip portion such that the tip portion nests within the pocket.

13. A nozzle plate for a spray gun applicator, the nozzle plate comprising:
a plate body configured to be rotatable coupled to a distal end of the spray gun body; and
a plurality of discrete nozzles on the plate body configured to be selectively and individually positioned in communication with the fluid passage of the spray gun body by rotating the nozzle plate relative to the distal end of the spray gun body about a rotational axis,
wherein at least one of the plurality of discrete nozzles is a wide nozzle defining an orifice having a proximal inlet and a distal outlet,
wherein the orifice flares from the proximal inlet to the distal outlet, and
wherein the distal outlet has an oblong shape.

14. The nozzle plate set forth in claim 13, wherein the distal outlet has an oval shape.

15. The nozzle plate set forth in claim 14, wherein the distal outlet has a stadium shape.

16. The nozzle plate set forth in claim 15, wherein at least one of the plurality of discrete nozzles is a conventional nozzle defining an orifice having a distal outlet with a circular shape.

17. The nozzle plate set forth in claim 13, wherein the wide nozzle comprises at least two wide nozzles, wherein the distal outlets of the at least two wide nozzles have different sizes.

18. The nozzle plate set forth in claim 17, wherein the distal outlets of the at least two wide nozzles have the same shapes.

19. The nozzle plate set forth in claim 13, wherein the proximal inlet of the orifice is oblong.

20. The nozzle plate set forth in claim 13, further comprising pockets at a proximal side of the nozzle plate body, each of the pockets in fluid communication with the proximal inlet of a corresponding one of the discrete nozzles, wherein each pocket is configured to receive a tip portion of the spray gun body such that the tip portion nests within the pocket.
